(19) United States
(12) Patent Application Publication
(10) Pub. No.: US 2021/0264307 A1
(43) Pub. Date: Aug. 26, 2021

(54) LEARNING DEVICE, INFORMATION PROCESSING SYSTEM, LEARNING METHOD, AND LEARNING PROGRAM

(71) Applicant: NEC Corporation, Minato-ku, Tokyo (JP)

(72) Inventor: Ryota HIGA, Tokyo (JP)

(73) Assignee: NEC Corporation, Minato-ku, Tokyo (JP)

(21) Appl. No.: 17/252,902

(22) PCT Filed: Jun. 26, 2018
(86) PCT No.: PCT/JP2018/024162

§ 371 Date: Dec. 16, 2020

(51) Int. Cl. G06N 7/00; G06N 3/08; G06F 9/448; G06K 9/62

(52) U.S. Cl. CPC G06N 7/005; G06K 9/6257; G06F 9/4498; G06N 3/08

(57) ABSTRACT

A model setting unit 81 sets, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy. A parameter estimation unit 82 estimates parameters of the physical equation by performing the reinforcement learning using training data including the state based on the set model. A difference detection unit 83 detects differences between previously estimated parameters of the physical equation and newly estimated parameters of the physical equation.

### TECHNICAL FIELD

The present invention relates to a learning device, an information processing system, a learning method, and a learning program for learning a model that estimates a system mechanism.

### BACKGROUND ART

Various algorithms for machine learning have been proposed in the field of artificial intelligence (AI). A data assimilation technique is a method of reproducing phenomena using a simulator. For example, the technique uses a numerical model to reproduce highly nonlinear natural phenomena. Other machine learning algorithms, such as deep learning, are also used to determine parameters of a large-scale simulator or to extract features.

For an agent that performs actions in an environment where states can change, reinforcement learning is known as a way of learning an appropriate action according to the environmental state. For example, Non Patent Literature (NPL) 1 describes a method for efficiently performing the reinforcement learning by adopting domain knowledge of statistical mechanics.

### CITATION LIST

### Non Patent Literature

NPL 1: Adam Lipowski, et al., “Statistical mechanics approach to a reinforcement learning model with memory”, Physica A vol. 388, pp. 1849-1856, 2009

### SUMMARY OF INVENTION

### Technical Problem

Many AIs need to define clear goals and evaluation criteria before preparing data. For example, while it is necessary to define a reward according to an action and a state in the reinforcement learning, the reward cannot be defined unless the fundamental mechanism is known. That is, common AIs can be said to be, not data-driven, but goal/evaluation method-driven.

Specifically, for determining the parameters of a large-scale simulator as described above, it is necessary to determine the goal, and in the data assimilation technique, the existence of the simulator is the premise. In feature extraction using deep learning, although it may be possible to determine which feature is effective, learning the same in itself requires certain evaluation criteria. The same applies to the method described in NPL 1.

Examples of the system for which it is desirable to estimate the mechanism include a variety of infrastructures surrounding our environment (hereinafter, referred to as infrastructure). For example, in the field of communications, a communication network is an example of the infrastructure. Social infrastructures include transport infrastructure, water supply infrastructure, and electric power infrastructure.

These infrastructures are desirably reviewed over time and in response to changes in the environment. For example, in the communications infrastructure, when the number of communication devices increases, it may be necessary to enhance the communication networks with increasing communication amounts. On the other hand, in the water supply infrastructure, for example, downsizing of the water supply infrastructure may be necessary in consideration of the reduction in water demand due to population decline and water conservation effects as well as the cost of renewal due to aging of the facilities and pipes.

To formulate a facility development plan for improving the efficiency of business management, as in the water supply infrastructure described above, it is necessary to optimize facility capacity and consolidate or abolish facilities while taking into consideration the future reduction in water demand and the timing of facility renewal. For example, when water demand is declining, downsizing may be done to reduce the amount of water by replacing pumps in facilities supplying excess water. Alternatively, the water distribution facility itself may be abolished, and pipelines from other water distribution facilities may be added to integrate (share) with other areas. With such downsizing, cost reduction and improved efficiency can be expected.

In order to change constituent elements of the infrastructure and formulate a future facility development plan, it is preferable to be able to prepare a simulator tailored to that domain. On the other hand, such an infrastructure consists of a system that combines various factors. In other words, when attempting to simulate the behavior of the infrastructure, all of the various combined factors need to be considered.

However, as mentioned previously, a simulator can be prepared only when the fundamental mechanism is known. Therefore, when developing a domain-specific simulator, a significant amount of computational time and cost is required, including understanding how the simulator itself is used, determining parameters, and exploring the solution to equations. In addition, the simulators developed are specialized, so additional training cost is required to make most use of the simulators. It is thus necessary to develop a flexible engine that cannot be described only by simulators using domain knowledge.

While many data items have been available in recent years, it is difficult to determine the goals and evaluation methods of systems having nontrivial mechanisms. Specifically, even if data can be collected, it is difficult to utilize the data without a simulator, and even if there is a simulator, it is difficult to judge which kinds of combinations with the observed data cause changes in the system. For example, the data assimilation itself requires computational costs for parameter exploration.

On the other hand, data can be taken sequentially by observing system phenomena, so it is preferable that a large number of pieces of data collected can be effectively used to estimate the changes in the systems representing nontrivial phenomena while reducing the costs.

In view of the foregoing, it is an object of the present invention to provide a learning device, an information processing system, a learning method, and a learning program capable of estimating a change in a system based on acquired data even if a mechanism of the system is nontrivial.

### Solution to Problem

A learning device according to the present invention includes: a model setting unit that sets, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; a parameter estimation unit that estimates parameters of the physical equation by performing the reinforcement learning using training data including the state based on the set model; and a difference detection unit that detects differences between previously estimated parameters of the physical equation and newly estimated parameters of the physical equation.

A learning method according to the present invention includes: setting, by a computer, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; estimating, by the computer, parameters of the physical equation by performing the reinforcement learning using training data including the state based on the set model; and detecting, by the computer, differences between previously estimated parameters of the physical equation and newly estimated parameters of the physical equation.

A learning program according to the present invention causes a computer to perform: model setting processing of setting, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; parameter estimation processing of estimating parameters of the physical equation by performing the reinforcement learning using training data including the state based on the set model; and difference detection processing of detecting differences between previously estimated parameters of the physical equation and newly estimated parameters of the physical equation.

### Advantageous Effects of Invention

The present invention enables estimation of a change in a system based on acquired data even if a mechanism of the system is nontrivial.

### BRIEF DESCRIPTION OF DRAWINGS

FIG. 1 It is a block diagram depicting an exemplary embodiment of an information processing system including a learning device according to the present invention.

FIG. 2 It depicts an example of processing of generating a physical simulator.

FIG. 3 It depicts an example of a relationship between changes in a physical engine and an actual system.

FIG. 4 It is a flowchart illustrating an exemplary operation of the learning device.

FIG. 5 It is a flowchart illustrating an exemplary operation of the information processing system.

FIG. 6 It depicts an example of processing of outputting differences in an equation of motion.

FIG. 7 It depicts an example of a physical simulator of an inverted pendulum.

FIG. 8 It is a block diagram depicting an outline of a learning device according to the present invention.

FIG. 9 It is a schematic block diagram depicting a configuration of a computer according to at least one exemplary embodiment.

### DESCRIPTION OF EMBODIMENT

Exemplary embodiments of the present invention will be described below with reference to the drawings. In the following, the description will be made by giving as appropriate an example of a water supply infrastructure as a target of estimation of changes in a system.

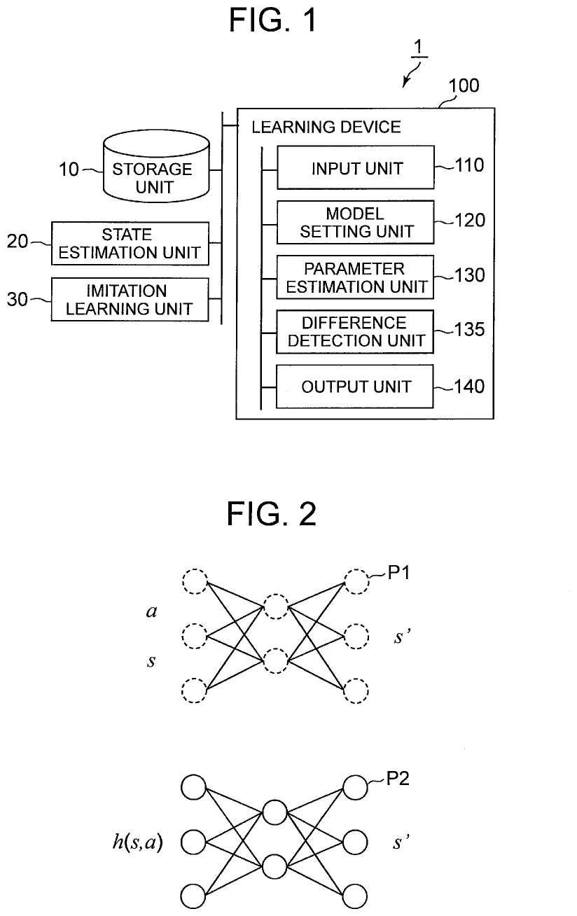

FIG. 1 is a block diagram depicting an exemplary embodiment of an information processing system including a learning device according to the present invention. An information processing system 1 of the present exemplary embodiment includes a storage unit 10, a learning device 100, a state estimation unit 20, and an imitation learning unit 30.

The storage unit 10 stores data (hereinafter, referred to as training data) that associates a state vector s=(s₁, s₂, . . . ) representing the state of a target environment with an action a performed in the state represented by the state vector. Assumed here are, as in general reinforcement learning, an environment (hereinafter, referred to as target environment) in which more than one state can be taken and a subject (hereinafter, referred to as agent) that can perform more than one action in the environment. In the following description, the state vector s may simply be denoted as state s. In the present exemplary embodiment, a system having a target environment and an agent interacting with each other will be assumed.

For example, in the case of the water supply infrastructure, the target environment is represented as a collection of states of the water supply infrastructure (e.g., water distribution network, capacities of pumps, states of piping, etc.). The agent corresponds to an operator that performs actions based on decision making, or an external system.

Other examples of the agent include a self-driving car. The target environment in this case is represented as a collection of states of the self-driving car and its surroundings (e.g., surrounding maps, other vehicle positions and speeds, and road states).

The action to be performed by the agent varies depending on the state of the target environment. In the case of the water supply infrastructure described above, water needs to be supplied to the demand areas on the water distribution network without any excess or deficiency. In the case of the self-driving car described above, it is necessary to proceed to avoid any obstacle existing in front. It is also necessary to change the driving speed of the vehicle according to the state of the road surface ahead, the distance between the vehicle and the vehicle ahead, and so on.

A function that outputs an action to be performed by the agent according to the state of the target environment is called a policy. The imitation learning unit 30, which will be described below, generates a policy by imitation learning. If the policy is learned to be ideal, the policy will output an optimal action to be performed by the agent according to the state of the target environment.

The imitation learning unit 30 performs imitation learning using data that associates a state vector s with an action a (i.e., the training data) to output a policy. The policy obtained by the imitation learning is to imitate the given training data. Here, the policy according to which an agent selects an action is represented as π, and the probability that an action a is selected in a state s under the policy π is represented as π(s, a). The way for the imitation learning unit 30 to perform imitation learning is not limited. The imitation learning unit 30 may use a general method to perform imitation learning to thereby output a policy.

For example, in the case of the water supply infrastructure, an action a represents a variable that can be controlled based on an operational rule, such as valve opening and closing, water withdrawal, pump threshold, etc. A state s represents a variable that describes the dynamics of the network that cannot be explicitly operated by the operator, such as the voltage, water level, pressure, and water volume at each location. That is, the training data in this case can be said to be data by which temporal and spatial information is explicitly provided (data dependent on time and space) and data in which a manipulated variable and a state variable are explicitly separated.

Further, the imitation learning unit 30 performs imitation learning to output a reward function. Specifically, the imitation learning unit 30 defines a policy which has, as an input to a function, a reward r(s) obtained by inputting a state vector s into a reward function r. That is, an action a obtained from the policy is defined by the expression 1 illustrated below.

a˜π(a|r(s)) (Expression 1)

That is, the imitation learning unit 30 may formulate the policy as a functional of a reward function. By performing the imitation learning using such a formulated policy, the imitation learning unit 30 can also learn the reward function while learning the policy.

The probability that a state s′ is selected based on a certain state s and action a can be expressed as π(a|s). When a policy is defined as in the expression 1 shown above, a reward function r(s, a) can be used to define a relationship of the expression 2 illustrated below. It should be noted that the reward function r(s, a) may also be denoted as rₐ(s).

π(a|s):=π(a|r(s, a)) (Expression 2)

The imitation learning unit 30 may learn the reward function r(s, a) by using a function formulated as in the expression 3 illustrated below. In the expression 3, λ′ and θ′ are parameters determined by the data, and g′(θ′) is a regularization term.

$$\begin{matrix}[ Math . 1 ] & \\ r ( s , a ) := {\sum }_{i}^{N} {θ}_{i}^{′} {s}_{i} + {\sum }_{j = N + 1} {θ}_{j}^{′} {a}_{j} + {λ}^{′} {g}^{′} ( {θ}^{′} ) & ( Expression 3 )\end{matrix}$$

The probability π(a|s) for the policy to be selected relates to the reward obtainable from an action a in a certain state s, so it can be defined using the above reward function rₐ(s) in the form of the expression 4 illustrated below. It should be noted that Z_{R} is a partition function, and Z_{R}=Σₐ exp(rₐ(s)).

$$\begin{matrix}[ Math . 2 ] & \\ π ( a \text{\textbar} S ) := \frac{exp ( {r}_{a} ( S ) )}{{Z}_{R}} & ( Expression 4 )\end{matrix}$$

The learning device 100 includes an input unit 110, a model setting unit 120, a parameter estimation unit 130, a difference detection unit 135, and an output unit 140.

The input unit 110 inputs training data stored in the storage unit 10 into the parameter estimation unit 130.

The model setting unit 120 models a problem to be targeted in reinforcement learning which is performed by the parameter estimation unit 130 as will be described later.

Specifically, in order for the parameter estimation unit 130, described later, to estimate parameters of a function by the reinforcement learning, the model setting unit 120 determines a rule of the function to be estimated.

Meanwhile, as indicated by the expression 4 above, it can be said that the policy π representing an action a to be taken in a certain state s has a relationship with the reward function r(s, a) for determining a reward r obtainable from a certain environmental state s and an action a selected in that state. Reinforcement learning is for finding an appropriate policy π through learning in consideration of the relationship.

On the other hand, the present inventor has realized that the idea of finding a policy π based on the state s and the action a in the reinforcement learning can be used to find a nontrivial system mechanism based on a certain phenomenon. As used herein, the system is not limited to a system that is mechanically configured, but also includes the above-described infrastructures as well as any system that exists in nature.

A specific example representing a probability distribution of a certain state is the Boltzmann distribution (Gibbs distribution) in statistical mechanics. From the standpoint of the statistical mechanics as well, when an experiment is conducted based on certain experimental data, a certain energy state occurs based on a prescribed mechanism, so this energy state is considered to correspond to a reward in the reinforcement learning.

In other words, it can be said that the above content explains that, similarly as in the reinforcement learning in which a policy can be estimated because a certain reward has been determined, in the statistical mechanics, an energy distribution can be estimated because a certain equation of motion has been determined. One reason why the relationships are associated in the above-described manner is that they are connected by the concept of entropy.

Generally, the energy state can be represented by a physical equation (e.g., a Hamiltonian) representing the physical quantity corresponding to the energy. Thus, the model setting unit 120 provides a problem setting for the function to be estimated in reinforcement learning, so that the parameter estimation unit 130, described later, can estimate the Boltzmann distribution in the statistical mechanics in the framework of the reinforcement learning.

Specifically, as a problem setting to be targeted in the reinforcement learning, the model setting unit 120 associates a policy π(a|s) for determining an action a to be taken in an environmental state s, with a Boltzmann distribution representing a probability distribution of a prescribed state. Furthermore, as the problem setting to be targeted in the reinforcement learning, the model setting unit 120 associates a reward function r(s, a) for determining a reward r obtainable from an environmental state s and an action selected in that state, with a physical equation (a Hamiltonian) representing a physical quantity corresponding to an energy. In this manner, the model setting unit 120 models the problem to be targeted by the reinforcement learning.

Here, when the Hamiltonian is represented as H, generalized coordinates as q, and generalized momentum as p, then the Boltzmann distribution f(q, p) can be represented by the expression 5 illustrated below. In the expression 5, β is a parameter representing a system temperature, and Z_{S} is a partition function.

$$\begin{matrix}[ Math . 3 ] & \\ f ( q , p ) = \frac{exp ( - βℋ ( q , p ) )}{{Z}_{S}} & ( Expression 5 )\end{matrix}$$

As compared with the expression 4 shown above, it can be said that the Boltzmann distribution in the expression 5 corresponds to the policy in the expression 4, and the Hamiltonian in the expression 5 corresponds to the reward function in the expression 4. In other words, it can be said, from the correspondence between the above expressions 4 and 5 as well, that the Boltzmann distribution in the statistical mechanics has been modeled successfully in the framework of the reinforcement learning.

A description will now be made about a specific example of a physical equation (Hamiltonian, Lagrangian, etc.) to be associated with a reward function r(s, a). In the present exemplary embodiment, for a state transition probability based on a physical equation h(s, a), Markov property is assumed, or in other words, it is assumed that a formula indicated by the following expression 6 holds.

p(s′|s, a)=p(s′|h(s, a)) (Expression 6)

The right side of the expression 6 can be defined as in the expression 7 shown below. In the expression 7, Z_{S} is a partition function, and Z_{S}=Σ_{S′} exp(h_{s′}(s, a)).

$$\begin{matrix}[ Math . 4 ] & \\ p ( {s}^{′} \text{\textbar} h ( s , a ) ) := \frac{exp ( {h}_{{s}^{′}} ( s , a ) )}{{Z}_{S}} & ( Expression 7 )\end{matrix}$$

When h(s, a) is given a condition that satisfies the law of physics, such as time reversal, space inversion, or quadratic form, then the physical equation h(s, a) can be defined as in the expression 8 shown below. In the expression 8, λ and θ are parameters determined by data, and g(θ) is a regularization term.

$$\begin{matrix}[ Math . 5 ] & \\ h ( s , a ) = {\sum }_{i , j}^{N} {θ}_{i} {s}_{i} {s}_{j} + {\sum }_{k = 2 N + 1} {θ}_{k} {a}_{k} + λ g ( θ ) & ( Expression 8 )\end{matrix}$$

Some energy states do not require actions. The model setting unit 120 can also express a state that involves no action, by setting an equation of motion in which an effect attributed to an action a and an effect attributed to a state s independent of the action are separated from each other, as shown in the expression 8.

Furthermore, as compared with the expression 3 shown above, each term of the equation of motion in the expression 8 can be associated with each term of the reward function in the expression 3. Thus, using the method of learning a reward function in the framework of the reinforcement function enables estimation of a physical equation. In this manner, the model setting unit 120, by performing the above-described processing, can design a model (specifically, a cost function) that is needed for learning by the parameter estimation unit 130 described below.

For example, in the case of the water distribution network described above, the model setting unit 120 sets a model in which a policy for determining an action to be selected in the water distribution network is associated with a Boltzmann distribution, and a state of the water distribution network and a reward function in that state are associated with a physical equation.

The parameter estimation unit 130 estimates parameters of a physical equation by performing reinforcement learning using training data including states s, based on the model set by the model setting unit 120. There are cases where an energy state does not need to involve an action, as described previously, so the parameter estimation unit 130 performs the reinforcement learning using training data that includes at least states s. The parameter estimation unit 130 may estimate the parameters of a physical equation by performing the reinforcement learning using training data that includes both states s and actions a.

For example, when a state of the system observed at time t is represented as sₜ and an action as aₜ, the data can be said to be a time series operational data set Dₜ={sₜ, aₜ} representing the action and operation on the system. In addition, estimating the parameters of the physical equation provides information simulating the behavior of the physical phenomenon, so it can also be said that the parameter estimation unit 130 generates a physical simulator.

The parameter estimation unit 130 may use a neural network, for example, to generate a physical simulator. FIG. 2 is a diagram depicting an example of processing of generating a physical simulator. A perceptron P1 illustrated in FIG. 2 shows that a state s and an action a are input to an input layer and a next state s′ is output at an output layer, as in a general method. On the other hand, a perceptron P2 illustrated in FIG. 2 shows that a simulation result h(s, a) determined according to a state s and an action a is input to the input layer and a next state s′ is output at the output layer.

Performing learning such as generating the perceptrons illustrated in FIG. 2 makes it possible to achieve formulation including an operator and obtain a time evolution operator, thereby enabling new theoretical proposal as well.

The parameter estimation unit 130 may also estimate the parameters by performing maximum likelihood estimation of a Gaussian mixture distribution.

The parameter estimation unit 130 may also use a product model and a maximum entropy method to generate a physical simulator. Specifically, a formula defined by the expression 9 illustrated below may be formulated as a functional of a physical equation h, as shown in the expression 10, to estimate the parameters. Performing the formulation shown in the expression 10 enables learning a physical simulator that depends on an operation (i.e., a≠0).

$$\begin{matrix}[ Math . 6 ] & \\ {∇}_{θ} ln {p}_{θ} ( {s}^{′} \text{\textbar} s , a ) = 0 & ( Expression 9 ) \\ \frac{δ}{δ h} ln p ( {s}^{′} \text{\textbar} h ( s , a ) ) = 0 & ( Expression 10 )\end{matrix}$$

As described previously, the model setting unit 120 has associated a reward function r(s, a) with a physical equation h(s, a), so the parameter estimation unit 130 can estimate a Boltzmann distribution as a result of estimating the physical equation using a method of estimating the reward function. That is, providing a formulated function as a problem setting for reinforcement learning makes it possible to estimate the parameters of an equation of motion in the framework of the reinforcement learning.

Further, with the equation of motion being estimated by the parameter estimation unit 130, it also becomes possible to extract a rule for a physical phenomenon or the like from the estimated equation of motion or to update the existing equation of motion.

For example, in the case of the water distribution network described above, the parameter estimation unit 130 may perform the reinforcement learning based on the set model, to estimate the parameters of a physical equation that simulates the water distribution network.

The difference detection unit 135 detects a change in environmental dynamics (state s) by detecting differences between previously estimated parameters of the physical equation and newly estimated parameters of the physical equation.

The way of detecting a difference between parameters is not limited. For example, the difference detection unit 135 may detect the difference by comparing the terms included in the physical equation and weights. Further, for example in the case where a physical simulator has been generated using a neural network as illustrated in FIG. 2, the difference detection unit 135 may compare the weights between the layers represented by the parameters to detect a change of the environmental dynamics (state s). In this case, the difference detection unit 135 may extract any unused environment (e.g., network) based on the detected difference. The unused environment thus detected can be a candidate for downsizing.

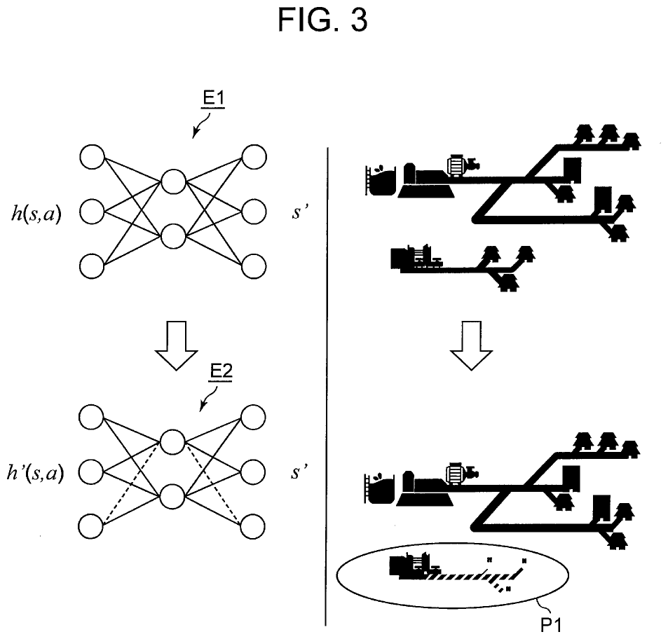

More specifically, the difference detection unit 135 detects, as the differences, changes of parameters of a function (physical engine) learned in a deep neural network (DNN) or a Gaussian process. FIG. 3 depicts an example of a relationship between changes in a physical engine and an actual system.

Suppose that, as a result of learning from the state of a physical engine E1 illustrated in FIG. 3, a physical engine E2 has been generated in which the weights between the layers indicated by the dotted lines have changed. Such changes of the weights are detected as the changes of the parameters. For example, when the physical engine is represented by the physical equation h(s, a) shown in the expression 8 above, the parameter θ changes in accordance with the change of the system. The difference detection unit 135 may thus detect the difference of the parameter θ in the expression 8. The parameter thus detected becomes a candidate for an unwanted parameter.

This change corresponds to a change in the actual system. For example, it can be said that, when the weights indicated by the dotted lines of the physical engine E2 have changed to approach zero, then the weights (degrees of importance) of the corresponding portions in the actual system have also approached an unnecessary state. In the example of the actual system in the water supply infrastructure, the portions include population decline and changes in the operational method from the outside. In this case, it can be determined that the corresponding portions of the actual system can be downsized.

In this manner, the difference detection unit 135 may detect a portion corresponding to a parameter that is no longer used (specifically, a parameter that has approached zero, a parameter that has become smaller than a predetermined threshold value) as a candidate for downsizing. In this case, the difference detection unit 135 may extract inputs sᵢ and aₖ of the corresponding portion. In the example of the water supply infrastructure, the inputs correspond to the pressure, water volume, operation method, etc. at each location. The difference detection unit 135 may then identify a portion in the actual system that can be downsized, based on the positional information of the corresponding data. As shown above, the actual system, the series data, and the physical engine have a relationship with each other, so the difference detection unit 135 can identify the actual system based on the extracted sᵢ and aₖ.

The output unit 140 outputs the equation of motion with its parameters estimated, to the state estimation unit 20 and the imitation learning unit 30. The output unit 140 also outputs the differences of the parameters detected by the difference detection unit 135.

Specifically, the output unit 140 may display, on a system capable of monitoring the water distribution network as illustrated in FIG. 3, the portion where the change in parameter has been detected by the difference detection unit 135, in a discernible manner. For example, in the case of downsizing the water distribution network, the output unit 140 may output information that clearly shows a portion P1 in the current water distribution network that can be downsized. Such information can be output by changing the color on the water distribution network, or by voice or text.

The state estimation unit 20 estimates a state from an action based on the estimated equation of motion. That is, the state estimation unit 20 operates as a physical simulator.

The imitation learning unit 30 performs imitation learning using an action and a state that the state estimation unit 20 has estimated based on that action, and may further perform processing of estimating a reward function.

On the other hand, the environment may be changed according to the difference detected. For example, suppose that an unused environment has been detected and downsizing has been made on part of the environment. The downsizing may be performed automatically or semi-automatically manually, depending on the content. In this case, the change in the environment may be fed back to the operation of the agent, probably causing a change in the operational data set Dₜ acquired as well.

For example, suppose that the current physical simulator is an engine that simulates the water distribution network prior to downsizing. When downsizing is performed from this state to eliminate some of the pumps, environmental changes may occur, such as increased distribution of the other pumps so as to compensate for the reduction due to the abolished pumps.

Accordingly, the imitation learning unit 30 may perform imitation learning using training data acquired in the new environment. The learning device 100 (more specifically, the parameter estimation unit 130) may then estimate the parameters of the physical equation by performing the reinforcement learning using the newly acquired operational data set. This makes it possible to update the physical simulator to suit the new environment.

Assuming the operation of the water distribution network using the physical simulator thus generated also enables simulating the states of other factors (e.g., increased power costs, operational costs after the decommission, replacement costs, etc.).

The above description was about the case in which feedback was provided to the operation of the agent and the operation was changed. Alternatively, the operation method may be changed due to, for example, a change of the person in charge using the actual system. In this case, the reward function may be changed by the imitation learning unit 30 through re-learning. In this case, the difference detection unit 135 may detect differences between previously estimated parameters of the reward function and newly estimated parameters of the reward function. The difference detection unit 135 may detect, for example, the differences of the parameters of the reward function shown in the expression 3 above.

Detecting the differences of the parameters of the reward function also enables automating the decision making by the operator. This is because the changes in decision-making rules appear in the learned policy and reward function. That is, in the present exemplary embodiment, the parameter estimation unit 130 estimates the parameters of the physical equation by reinforcement learning, so it is possible to treat the network, which is a physical phenomenon or artifact, and the decision-making device in an interactive manner.

Examples of such automation include, for example, automation of operations using robotic process automation (RPA), robots, etc., and also covers from the function of assisting new employees to full automation of the operation of external systems. In particular, in public works projects where there are personnel changes every few years, the above automation reduces the impact of changes in decision-making rules after the skilled workers left.

The learning device 100 (more specifically, the input unit 110, the model setting unit 120, the parameter estimation unit 130, the difference detection unit 135, and the output unit 140), the state estimation unit 20, and the imitation learning unit 30 are implemented by a processor (e.g., a central processing unit (CPU), a graphics processing unit (GPU), a field-programmable gate array (FPGA)) of a computer that operates in accordance with a program (the learning program).

For example, the program may be stored in a storage unit (not shown) included in the information processing system 1, and the processor may read the program and operate as the learning device 100 (more specifically, the input unit 110, the model setting unit 120, the parameter estimation unit 130, the difference detection unit 135, and the output unit 140), the state estimation unit 20, and the imitation learning unit 30 in accordance with the program. Further, the functions of the information processing system 1 may be provided in the form of Software as a Service (SaaS).

The learning device 100 (more specifically, the input unit 110, the model setting unit 120, the parameter estimation unit 130, the difference detection unit 135, and the output unit 140), the state estimation unit 20, and the imitation learning unit 30 may each be implemented by dedicated hardware. Further, some or all of the components of each device may be implemented by general purpose or dedicated circuitry, processors, etc., or combinations thereof. They may be configured by a single chip or a plurality of chips connected via a bus. Some or all of the components of each device may be implemented by a combination of the above-described circuitry or the like and the program.

Further, when some or all of the components of the information processing system 1 are realized by a plurality of information processing devices or circuits, the information processing devices or circuits may be disposed in a centralized or distributed manner. For example, the information processing devices or circuits may be implemented in the form of a client server system, a cloud computing system, or the like, in which the devices or circuits are connected via a communication network.

Further, the storage unit 10 is implemented by, for example, a magnetic disk or the like.

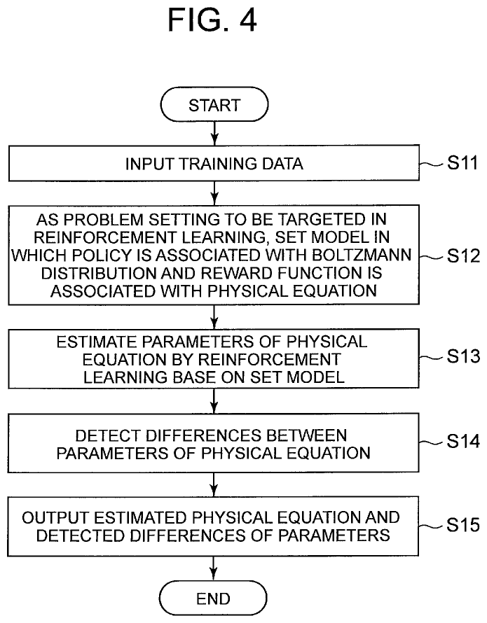

An operation of the learning device 100 of the present exemplary embodiment will now be described. FIG. 4 is a flowchart illustrating an exemplary operation of the learning device 100 of the present exemplary embodiment. The input unit 110 inputs training data which is used by the parameter estimation unit 130 for learning (step S11). The model setting unit 120 sets, as a problem setting to be targeted in reinforcement learning, a model in which a policy is associated with a Boltzmann distribution and a reward function is associated with a physical equation (step S12). It should be noted that the model setting unit 120 may set the model before the training data is input (i.e., prior to step S11).

The parameter estimation unit 130 estimates parameters of the physical equation by the reinforcement learning, based on the set model (step S13). The difference detection unit 135 detects differences between previously estimated parameters of the physical equation and newly estimated parameters of the physical equation (step S14). Then, the output unit 140 outputs the physical equation represented by the estimated parameters and the detected differences of the parameters (step S15).

It should be noted that the parameters of the physical equation (i.e., physical simulator) are updated sequentially based on new data, and new parameters of the physical equation are estimated.

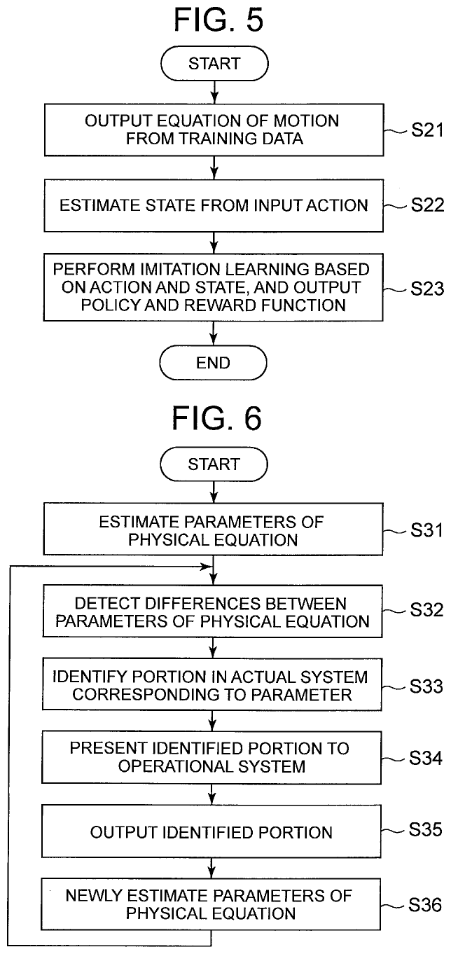

Next, an operation of the information processing system 1 of the present exemplary embodiment will be described. FIG. 5 is a flowchart illustrating an exemplary operation of the information processing system 1 of the present exemplary embodiment. The learning device 100 outputs an equation of motion from training data by the processing illustrated in FIG. 4 (step S21). The state estimation unit 20 uses the output equation of motion to estimate a state s from an input action a (step S22). The imitation learning unit 30 performs imitation learning based on the input action a and the estimated state s, to output a policy and a reward function (step S23).

FIG. 6 depicts an example of processing of outputting differences in an equation of motion. The parameter estimation unit 130 estimates parameters of the physical equation based on the set model (step S31). The difference detection unit 135 detects differences between previously estimated parameters of the physical equation and newly estimated parameters of the physical equation (step S32). Further, the difference detection unit 135 identifies, from the detected parameters, a corresponding portion in the actual system (step S33). At this time, the difference detection unit 135 may identify a portion in the actual system corresponding to a parameter that has become smaller than a predetermined threshold value, from among the parameters for which the difference has been detected. The difference detection unit 135 presents the identified portion to the system (operational system) operating the environment (step S34).

The output unit 140 outputs the identified portion of the actual system in a discernible manner (step S35). For the identified portion, a proposed operation plan is prepared automatically or semi-automatically and applied to the system. Series data is acquired in succession according to the new operation, and the parameter estimation unit 130 estimates new parameters of the physical equation (step S36). Thereafter, the processing in steps S32 and on is repeated.

As described above, in the present exemplary embodiment, the model setting unit 120 sets, as a problem setting to be targeted in reinforcement learning, a model in which a policy is associated with a Boltzmann distribution and a reward function is associated with a physical equation, and the parameter estimation unit 130 estimates parameters of the physical equation by performing the reinforcement learning based on the set model. Further, the difference detection unit 135 detects differences between previously estimated parameters of the physical equation and newly estimated parameters of the physical equation. Accordingly, it is possible to estimate a change in a system based on acquired data even if a mechanism of the system is nontrivial.

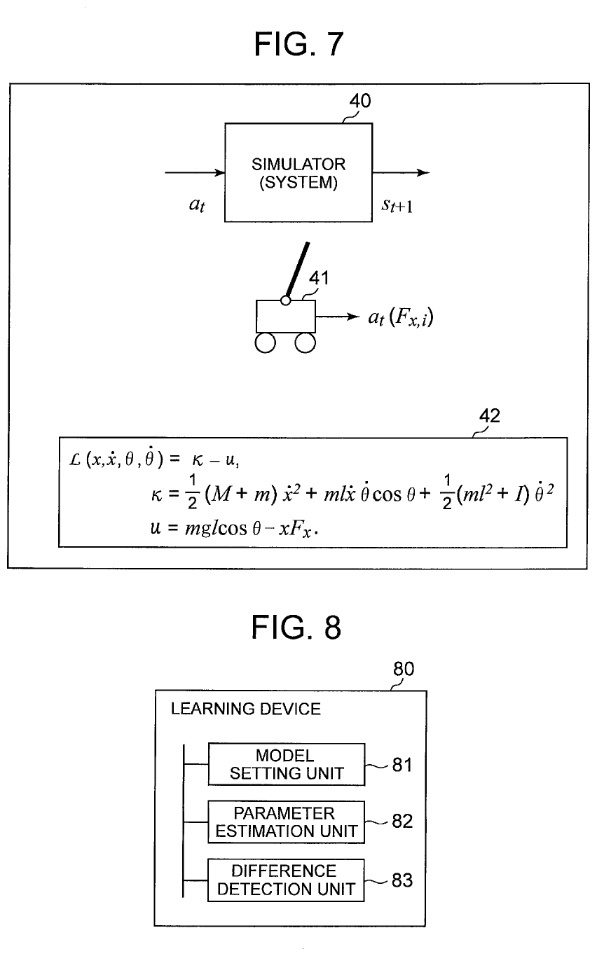

A specific example of the present invention will now be described with a method of estimating an equation of motion for an inverted pendulum. FIG. 7 depicts an example of a physical simulator of an inverted pendulum. The simulator (system) 40 illustrated in FIG. 7 estimates a next state sₜ₊₁ with respect to an action aₜ of the inverted pendulum 41 at a certain time t. Although the equation 42 of motion of the inverted pendulum is known as illustrated in FIG. 7, it is here assumed that the equation 42 of motion is unknown.

A state sₜ at time t is represented by the expression 11 shown below.

[Math. 7]

sₜ={xₜ,\dot{x}ₜ,θₜ,\dot{θ}ₜ} (Expression 11)

For example, suppose that the data illustrated in the expression 12 below has been observed as the action (operation) of the inverted pendulum.

$$\begin{matrix}[ Math . 8 ] & \\ \begin{matrix}{x}_{i + 1} = {x}_{i} + T {\dot{x}}_{i} & {\ddot{x}}_{i} = {T}_{i} - \frac{ml {\ddot{θ}}_{i}}{M + m} cos {θ}_{i} \\ {x}_{i + 1} = {\dot{x}}_{i} + T {\ddot{x}}_{i} & \\ {θ}_{i + 1} = {θ}_{i} + T {\dot{θ}}_{i} & {T}_{i} := \frac{{F}_{x , i} + ml {θ}_{i} sin {θ}_{i}}{M + m} \\ {\dot{θ}}_{i + 1} = {\dot{θ}}_{i} + T {\ddot{θ}}_{i} \cdot & {\ddot{θ}}_{i} = \frac{g sin {θ}_{i} - {T}_{i} cos {θ}_{i}}{\frac{4}{3} l - \frac{ml {cos}^{2} {θ}_{i}}{M + m}} \\ Δ t := T > 0 & \end{matrix} & ( Expression 12 )\end{matrix}$$

Here, the model setting unit 120 sets the equation of motion of the expression 8 shown above, and the parameter estimation unit 130 performs reinforcement learning based on the observed data shown in the above expression 11, whereby the parameters of h(s, a) shown in the expression 8 can be learned. The equation of motion learned in this manner represents a preferable operation in a certain state, so it can be said to be close to a system representing the motion of the inverted pendulum. By learning in this way, it is possible to estimate the system mechanism even if the equation of motion is unknown.

In addition to the inverted pendulum described above, a harmonic oscillator or a pendulum, for example, is also effective as a system the operation of which can be confirmed.

An outline of the present invention will now be described. FIG. 8 is a block diagram depicting an outline of a learning device according to the present invention. The learning device 80 according to the present invention (e.g., the learning device 100) includes: a model setting unit 81 (e.g., the model setting unit 120) that sets, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; a parameter estimation unit 82 (e.g., the parameter estimation unit 130) that estimates parameters of the physical equation by performing the reinforcement learning using training data including the state (e.g., the state vector s) based on the set model; and a difference detection unit 83 (e.g., the difference detection unit 135) that detects differences between previously estimated parameters of the physical equation and newly estimated parameters of the physical equation.

Such a configuration enables estimating a change in a system based on acquired data even if a mechanism of the system is nontrivial.

The difference detection unit 83 may detect, from among the newly estimated parameters of the physical equation, a parameter that has become smaller than a predetermined threshold value (e.g., a parameter approaching zero). Such a configuration can identify where in the environment the degree of importance has declined.

The learning device 80 may also include an output unit (e.g., the output unit 140) that outputs a state of a target environment. Then, the difference detection unit 83 may identify a portion in the environment corresponding to the parameter that has become smaller than the predetermined threshold value, and the output unit may output the identified portion of the environment in a discernible manner. Such a configuration allows the user to readily identify the portion where a change should be made in the target environment.

The difference detection unit 83 may detect, as the differences, changes of the parameters of the physical equation learned in a deep neural network or a Gaussian process.

Specifically, the model setting unit 81 may set a model in which a policy for determining an action to be selected in a water distribution network is associated with a Boltzmann distribution, and a state of the water distribution network and a reward function in that state are associated with a physical equation. The parameter estimation unit 82 may then perform the reinforcement learning based on the set model, to estimate the parameters of the physical equation simulating the water distribution network.

In this case, the difference detection unit 83 may extract a portion corresponding to a parameter among the newly estimated parameters of the physical equation that has become smaller than a predetermined threshold value, as a candidate for downsizing.

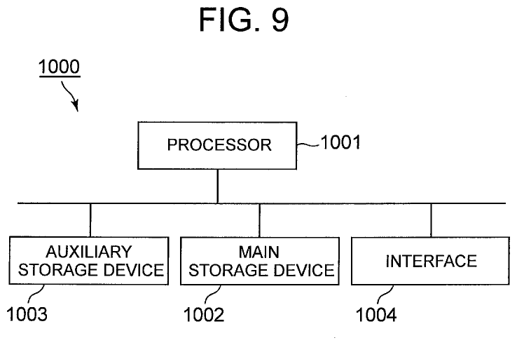

FIG. 9 is a schematic block diagram depicting a configuration of a computer according to at least one exemplary embodiment. The computer 1000 includes a processor 1001, a main storage device 1002, an auxiliary storage device 1003, and an interface 1004.

The learning device 80 described above is implemented in a computer 1000. The operations of each processing unit described above are stored in the auxiliary storage device 1003 in the form of a program (the learning program). The processor 1001 reads the program from the auxiliary storage device 1003 and deploys the program to the main storage device 1002 to perform the above-described processing in accordance with the program.

In at least one exemplary embodiment, the auxiliary storage device 1003 is an example of a non-transitory tangible medium. Other examples of the non-transitory tangible medium include a magnetic disk, magneto-optical disk, compact disc read-only memory (CD-ROM), DVD read-only memory (DVD-ROM), semiconductor memory, and the like, connected via the interface 1004. In the case where the program is delivered to the computer 1000 via a communication line, the computer 1000 receiving the delivery may deploy the program to the main storage device 1002 and perform the above-described processing.

In addition, the program may be for implementing a part of the functions described above. Further, the program may be a so-called differential file (differential program) that realizes the above-described functions in combination with another program already stored in the auxiliary storage device 1003.

Some or all of the above exemplary embodiments may also be described as, but not limited to, the following supplementary notes.

(Supplementary note 1) A learning device comprising: a model setting unit configured to set, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; a parameter estimation unit configured to estimate parameters of the physical equation by performing the reinforcement learning using training data including the state based on the set model; and a difference detection unit configured to detect differences between previously estimated parameters of the physical equation and newly estimated parameters of the physical equation.

(Supplementary note 2) The learning device according to supplementary note 1, wherein the difference detection unit detects a parameter that has become smaller than a predetermined threshold value from among the newly estimated parameters of the physical equation.

(Supplementary note 3) The learning device according to supplementary note 2, comprising an output unit configured to output a state of a target environment, wherein the difference detection unit identifies a portion in the environment corresponding to the parameter that has become smaller than the predetermined threshold value, and the output unit outputs the identified portion of the environment in a discernible manner.

(Supplementary note 4) The learning device according to any one of supplementary notes 1 to 3, wherein the difference detection unit detects, as the differences, changes of the parameters of the physical equation learned in a deep neural network or a Gaussian process.

(Supplementary note 5) The learning device according to any one of supplementary notes 1 to 4, wherein the model setting unit sets a model in which a policy for determining an action to be selected in a water distribution network is associated with a Boltzmann distribution, and a state of the water distribution network and a reward function in the state are associated with a physical equation, and the parameter estimation unit performs the reinforcement learning based on the set model to estimate parameters of the physical equation that simulates the water distribution network.

(Supplementary note 6) The learning device according to supplementary note 5, wherein the difference detection unit detects a portion corresponding to a parameter among the newly estimated parameters of the physical equation that has become smaller than a predetermined threshold value, as a candidate for downsizing.

(Supplementary note 7) The learning device according to any one of supplementary notes 1 to 6, wherein the parameter estimation unit estimates the parameters of the physical equation by performing the reinforcement learning using training data including the state and the action based on the set model.

(Supplementary note 8) The learning device according to any one of supplementary notes 1 to 7, wherein the model setting unit sets a physical equation having an effect attributable to the action and an effect attributable to the state separated from each other.

(Supplementary note 9) The learning device according to any one of supplementary notes 1 to 8, wherein the model setting unit sets a model having the reward function associated with a Hamiltonian.

(Supplementary note 10) A learning method comprising: setting, by a computer, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; estimating, by the computer, parameters of the physical equation by performing the reinforcement learning using training data including the state based on the set model; and detecting, by the computer, differences between previously estimated parameters of the physical equation and newly estimated parameters of the physical equation.

(Supplementary note 11) The learning method according to supplementary note 10, comprising detecting, by the computer, a parameter that has become smaller than a predetermined threshold value from among the newly estimated parameters of the physical equation.

(Supplementary note 12) A learning program causing a computer to perform: model setting processing of setting, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; parameter estimation processing of estimating parameters of the physical equation by performing the reinforcement learning using training data including the state based on the set model; and difference detection processing of detecting differences between previously estimated parameters of the physical equation and newly estimated parameters of the physical equation.

(Supplementary note 13) The learning program according to supplementary note 12, causing the computer, in the difference detection processing, to detect a parameter that has become smaller than a predetermined threshold value from among the newly estimated parameters of the physical equation.

### REFERENCE SIGNS LIST

1 information processing system

10 storage unit

20 state estimation unit

30 imitation learning unit

100 learning device

110 input unit

120 model setting unit

130 parameter estimation unit

135 difference detection unit

140 output unit

What is claimed is:

1. A learning device comprising a hardware processor configured to execute a software code to:
set, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy;
estimate parameters of the physical equation by performing the reinforcement learning using training data including the state based on the set model; and
detect differences between previously estimated parameters of the physical equation and newly estimated parameters of the physical equation.

2. The learning device according to claim 1, wherein the hardware processor is configured to execute a software code to detect a parameter that has become smaller than a predetermined threshold value from among the newly estimated parameters of the physical equation.

3. The learning device according to claim 2, wherein the hardware processor is configured to execute a software code to:
identify a portion in the environment corresponding to the parameter that has become smaller than the predetermined threshold value; and
output the identified portion of the environment in a discernible manner.

4. The learning device according to claim 1 wherein the hardware processor is configured to execute a software code to detect, as the differences, changes of the parameters of the physical equation learned in a deep neural network or a Gaussian process.

5. The learning device according to claim 1 wherein the hardware processor is configured to execute a software code to:
set a model in which a policy for determining an action to be selected in a water distribution network is associated with a Boltzmann distribution, and a state of the water distribution network and a reward function in the state are associated with a physical equation, and
perform the reinforcement learning based on the set model to estimate parameters of the physical equation that simulates the water distribution network.

6. The learning device according to claim 5, wherein the hardware processor is configured to execute a software code to detect a portion corresponding to a parameter among the newly estimated parameters of the physical equation that has become smaller than a predetermined threshold value, as a candidate for downsizing.

7. The learning device according to claim 1 wherein the hardware processor is configured to execute a software code to estimate the parameters of the physical equation by performing the reinforcement learning using training data including the state and the action based on the set model.

8. The learning device according to claim 1 wherein the hardware processor is configured to execute a software code to set a physical equation having an effect attributable to the action and an effect attributable to the state separated from each other.

9. The learning device according to claim 1 wherein the hardware processor is configured to execute a software code to set a model having the reward function associated with a Hamiltonian.

10. A learning method comprising:
setting, by a computer, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy;
estimating, by the computer, parameters of the physical equation by performing the reinforcement learning using training data including the state based on the set model; and
detecting, by the computer, differences between previously estimated parameters of the physical equation and newly estimated parameters of the physical equation.

11. The learning method according to claim 10, comprising detecting, by the computer, a parameter that has become smaller than a predetermined threshold value from among the newly estimated parameters of the physical equation.

12. A non-transitory computer readable information recording medium storing a learning program, when executed by a processor, that performs a method for:
setting, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy;
estimating parameters of the physical equation by performing the reinforcement learning using training data including the state based on the set model; and
detecting differences between previously estimated parameters of the physical equation and newly estimated parameters of the physical equation.

13. The non-transitory computer readable information recording medium according to claim 12, comprising detecting a parameter that has become smaller than a predetermined threshold value from among the newly estimated parameters of the physical equation.
